(19) United States
(12) Patent Application Publication
(10) Pub. No.: US 2011/0045735 A1
(43) Pub. Date: Feb. 24, 2011

(54) Fluid Engine and Method of Use Thereof

(76) Inventor: John McGaha, Monroe, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/545,169

(22) Filed: Aug. 21, 2009

(51) Int. Cl. A63H 3/46; F03G 3/00

(52) U.S. Cl. 446/376; 185/29

(57) ABSTRACT

A fluid engine for a figure having a movable appendage, wherein the fluid engine comprises a pivoting container partially filled with fluid disposed within a cavity in the figure. A connector is disposed between the fluid engine and the appendage. Centrifugal force acts upon the fluid within the container and the fluid urges the container to change its disposition, thereby causing the appendage to move.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

cl BACKGROUND OF THE INVENTION

1. Technical Field of the Invention

The present invention relates generally to apparatuses for providing power from the action of centrifugal force upon a fluid, and more specifically to a fluid engine and method of use thereof, wherein the fluid engine utilizes centrifugal force on a fluid within a container to cause motion of the container, and wherein the container is operatively connected to an appendage of a figure, thereby moving the appendage.

2. Description of Related Art

One such previous device exists that utilizes a weighted container that can be rocked from side to side by touching the container, wherein the container has a fluid therewithin, thereby providing a wave motion to move a floating object riding on the surface of the fluid. However, such a device requires a container that is weighted, the touching input, and, further, does not provide any means for moving an external object.

Other devices exist that utilize a rising wave to lift a floating object that then can provide motive power to another device. However, such devices require gravitational forces and buoyancy of the floating object to function.

Still other devices are merely decorative in nature and provide a container with fluid therein, wherein the container is rocked by a motor or similar device to provide a pleasant, wave motion for visual observation. Some of these devices comprise different immiscible liquids or entrainment of gas bubbles to augment the appearance aspects.

Therefore, it is readily apparent that there is a need for a fluid engine that can be disposed within a figure, wherein the fluid is disposed in a container within the fluid engine and is acted upon by centrifugal force to cause movement of the container, resulting in movement of an appendage of the figure.

### BRIEF SUMMARY OF THE INVENTION

Briefly described, in a preferred embodiment, the present invention overcomes the above-mentioned disadvantages and meets the recognized need for such an apparatus by providing a fluid engine for an action figure having a movable appendage, wherein the fluid engine comprises a pivoting container partially filled with fluid disposed within a cavity in the action figure. The fluid engine and the appendage are in operative communication through a connector. Centrifugal force acts upon the fluid within the container and the fluid, once moved by centrifugal force, urges the container to change its disposition by changing the weight distribution within the container, thereby causing the appendage to move.

According to its major aspects and broadly stated, the present invention in its preferred form is a fluid engine comprising a less than full container and a fluid disposed within the container, wherein centrifugal force operates on the fluid, thereby moving the container, and wherein the container urges an operatively-coupled appendage from one disposition to another.

A first movable member that is hingedly-coupled to the operatively-coupled appendage is in communication between the operatively-coupled appendage and the container. The container is disposed on a pivot and the container generally comprises a cylinder having a width and a length, wherein the length is disposed generally vertically. Alternatively, the container may comprise a rectangular prism having a length, a width and a height, wherein the length is disposed generally horizontally.

The fluid engine also comprises a figure having the operatively-coupled appendage, wherein the figure may be disposed within a vehicle, such as, without limitation, on the dashboard of a car. The figure with the fluid engine therein may be secured to a surface, such as the aforementioned dashboard via an adhesive, hook-and-loop fastener, magnets or the like. The container pivots on a curved bottom of a cavity within the figure, thereby allowing movement caused by centrifugal forces acting upon the container when the vehicle turns.

The first movable member is alternatively in pivotal communication with a second movable member that has at least a portion thereof slidably disposed within a retaining member. The second movable member is disposed between the first movable member and the operatively-coupled appendage, wherein the second movable member is rotated by the first movable member.

The arm member is operatively-coupled to the container and is moved by the fluid engine comprising a container, wherein the container is less than full of fluid. Centrifugal force acts upon the fluid within the fluid engine causing the container to move on a pivot point. The container is connected to a portion of a first movable member that is connected to the arm member, wherein the first movable member is urged from one disposition to another, thereby moving the arm member. The fluid engine is disposed within a figure.

In an alternate embodiment, a second movable member is urged by the first movable member. In another alternate embodiment, the second movable member is slidably urged by the first movable member.

More specifically, the present invention is a fluid engine with a fluid disposed within a container that is less than full of fluid. In the preferred embodiment, the fluid engine is disposed within a figure and the fluid engine provides power for movement of an appendage to the figure. A connector having a pivot is in rigid communication with the container and the appendage, thereby retaining the container and the appendage in rigid alignment. The figure is supported by a lower portion on a base that may selectively include a fastener for securing the figure within vehicle, such as on the dashboard, and the fastener may comprise, for exemplary purposes only, a magnet, hook-and-loop fasteners, adhesive, or the like.

The container is disposed within a cavity of the figure, wherein the cavity permits pivotal movement of the container about a pivot. The top of the container travels from one position to another and the reverse. As the vehicle travels around a curve, fluid in the container is operated upon by centrifugal force generated by the vehicle turning. The centrifugal force causes the fluid to move its location in the container in a direction opposite to the direction that the vehicle is turning. The weight of the fluid in the new location and/or the forces acting on the fluid cause the container to move and thus through coupling to the appendage, the appendage is caused to move from a first location to a second location. In this fashion, the figure appears to perform an athletic move, such as, for exemplary purposes only, kicking or throwing a football that is disposed near or on the appendage. It will be recognized by those skilled in the art that any force, including without limitation and by way of example forces applied by vehicular braking, could be utilized to cause fluid motion without departing from the spirit of the preferred embodiment.

In use, the figure containing the fluid engine is disposed on the dashboard of the vehicle. As the vehicle turns, centrifugal force is applied to the container moving same within the cavity in a direction opposite to the direction of the turn. As the container moves, the appendage, being operatively connected to the container, also moves, thereby giving the appearance of performing the designed operation of the figure.

In an alternate embodiment, the fluid engine comprises a container disposed within a cavity in the figure. The fluid engine has a bottom surface that is disposed within a curved bottom portion of the cavity, thereby permitting the container to pivot back-and-forth within the cavity from one position to another. The container further comprises a movable pivot that is in communication with a plate that has a fixed pivot at the other end from the movable pivot. The fixed pivot is in communication with a rod that is retained by holders that permit rotation of the rod. The rod is secured to an arm by a joint, and rotation of the rod within the holders causes the arm to move from one position to another as the container moves from one position to another within the cavity. As the arm moves from one position to another, it appears to give the figure the appearance of throwing a football. It will be recognized by those skilled in the art that other movements of appendages of the figure could be envisioned to provide different appearing movements without limitation.

In another alternate embodiment, the fluid engine comprises a container having a first end, a second end and an interior, and the fluid engine further comprises a pivot point and a base. The container is supported on the base and is secured thereto via a pivot point that permits the container to rock back-and-forth about the pivot point.

Fluid is disposed within the interior of the container. Under centrifugal force, the fluid moves, as applicable, from the first end toward the second end and in reverse. As the fluid moves, the weight of increased fluid at the end toward which it has moved causes the container to rock on the pivot point. The fluid engine further comprises a first hinge disposed on the second end, wherein the first hinge is in communication with a first member, and wherein the first member comprises a second hinge at the end of the first member opposite to the first hinge. The second hinge is in communication with the second member, wherein the second member is disposed within a sleeve. The second member comprises a joint at the end of second member opposite to the second hinge. The joint may be secured to the appendage or another object for which movement is desired.

As centrifugal force causes the container to rock back-and-forth, the second end moves up-and-down, pulling and/or pushing the first member. As the second end tilts upward, the first member pulls the second member, wherein the second member slides within the sleeve causing the joint to move to one position. Similarly, as the second end tilts downward, the first member pulls the second member, wherein the second member slides within the sleeve causing the joint to move to the same position. As the container reaches a level position, the first member pushes the second member, wherein the second member slides within the sleeve causing the joint to move to a different position from those above.

Accordingly, a feature and advantage of the present invention is its ability to utilize centrifugal force to provide movement of an appendage of a selected figure, thereby giving the figure the appearance of performing a selected operation.

Another feature and advantage of the present invention is its ability to productively utilize energy that would otherwise be wasted.

Still another feature and advantage of the present invention is its ability to be disposed within any selected figure design that has an appendage for which movement is desired.

Yet another feature and advantage of the present invention is that it can provide rotational or linear movement.

Yet still another feature and advantage of the present invention is that it can utilize a variety of fluids.

A further feature and advantage of the present invention is its ability to utilize a change of weight distribution of a fluid within a container to move an appendage operatively connected to the container.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a left side perspective view according to a preferred embodiment depicting a figure powered by a fluid engine in a first position;

FIG. 2 is a left side perspective view according to a preferred embodiment depicting a figure powered by a fluid engine in a second position;

FIG. 3 is a rear perspective view according to a preferred embodiment depicting a figure powered by a fluid engine;

FIG. 4 is a left side perspective view according to an alternate embodiment showing a figure powered by a fluid engine in a first position;

FIG. 5 is a left side perspective view according to an alternate embodiment depicting a figure powered by a fluid engine in a second position;

FIG. 6 is a rear perspective view according to an alternate embodiment showing a figure powered by a fluid engine;

FIG. 7 is a front perspective view showing a fluid engine according to an alternate embodiment, shown in a first position;

FIG. 8 is a front perspective view depicting a fluid engine according to an alternate embodiment, shown in a second position; and

FIG. 9 is a front perspective view showing a fluid engine according to an alternate embodiment, shown in a third position.

### DETAILED DESCRIPTION OF THE PREFERRED AND SELECTED ALTERNATE EMBODIMENTS OF THE INVENTION

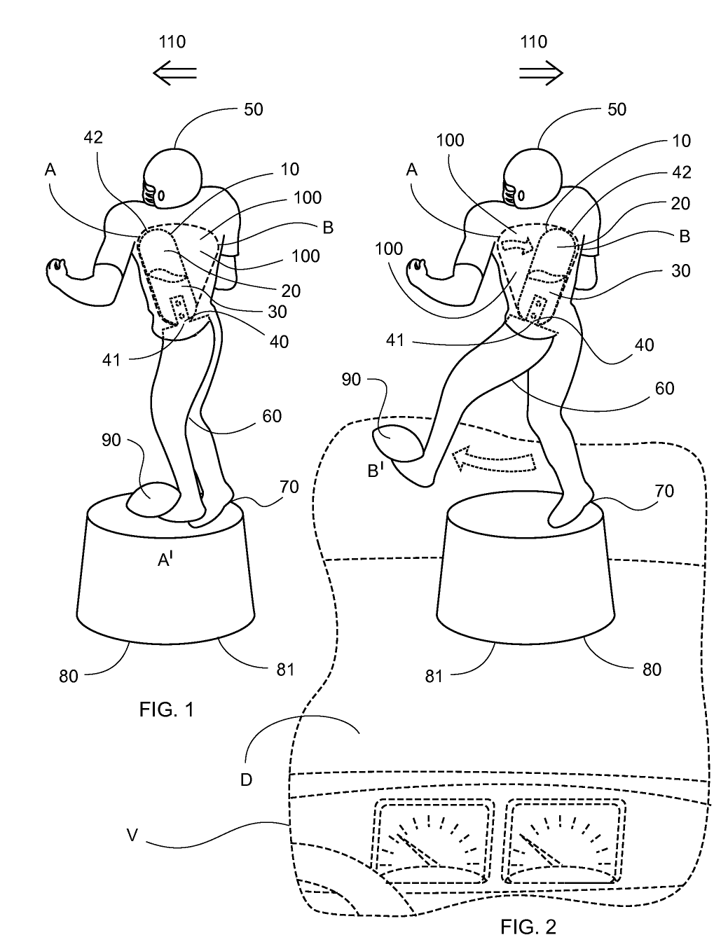

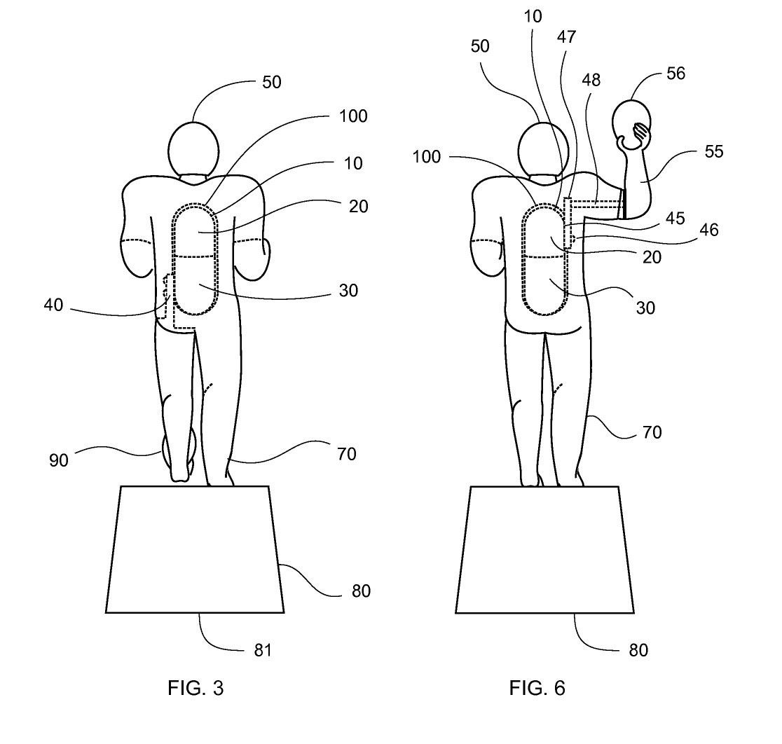

In describing the preferred and selected alternate embodiments of the present invention, as illustrated in FIGS. 1-9, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment is fluid engine 10, wherein fluid engine 10 preferably comprises container 20, fluid 30 and connector 40, wherein fluid 30 can be any fluid and is selected based on its density, wherein more dense fluids will provide greater force to move container 20 and any member connected thereto. Fluid 30 is preferably disposed within container 20, wherein container 20 is preferably less than full of fluid 30.

Fluid engine 10 is preferably disposed within FIG. 50, wherein fluid engine 10 is preferably utilized to provide power for movement of appendage 60 of FIG. 50. Connector 40 preferably comprises pivot 41, wherein connector 40 is preferably in rigid communication with container 20 and appendage 60 of FIG. 50, thereby preferably retaining container 20 and appendage 60 in rigid alignment. FIG. 50 is preferably supported by lower portion 70, wherein lower portion 70 is preferably disposed on base 80, wherein base 80 could comprise fastener 81, such as, for exemplary purposes only a magnet, hook-and-loop fasteners, adhesive, or the like, for securing FIG. 50 within vehicle V, such as on dashboard D.

Container 20 is preferably disposed within cavity 100 of FIG. 50, wherein cavity 100 preferably permits pivotal movement of container 20 about pivot 41, wherein top 42 of container 20 preferably travels from position A to position B and vice versa. As vehicle V travels around a curve, fluid 30 in container 20 is operated upon by centrifugal force 110 generated by vehicle V turning, wherein under force of fluid 30, as fluid 30 shifts its weight distribution within container 20, the change in weight distribution of fluid 30 within container 20 causes container 20 to preferably pivotally move opposite to the direction of turning vehicle V, thereby preferably causing appendage 60, which is operatively connected to container 20, to move from B′ to A′, opposite to the direction of motion of top 42. In this fashion, FIG. 50 can be made to appear to perform an operation, such as, for exemplary purposes only, kicking football 90, wherein football 90 is disposed proximate appendage 60.

In use, FIG. 50 containing fluid engine 10 is preferably disposed on dashboard D of vehicle V. As vehicle V turns, centrifugal force 110 is applied to container 20 moving same in a direction opposite to the direction of the turn. As container 20 moves, appendage 60, being operatively connected to container 20, also moves, giving the appearance of performing its designed operation.

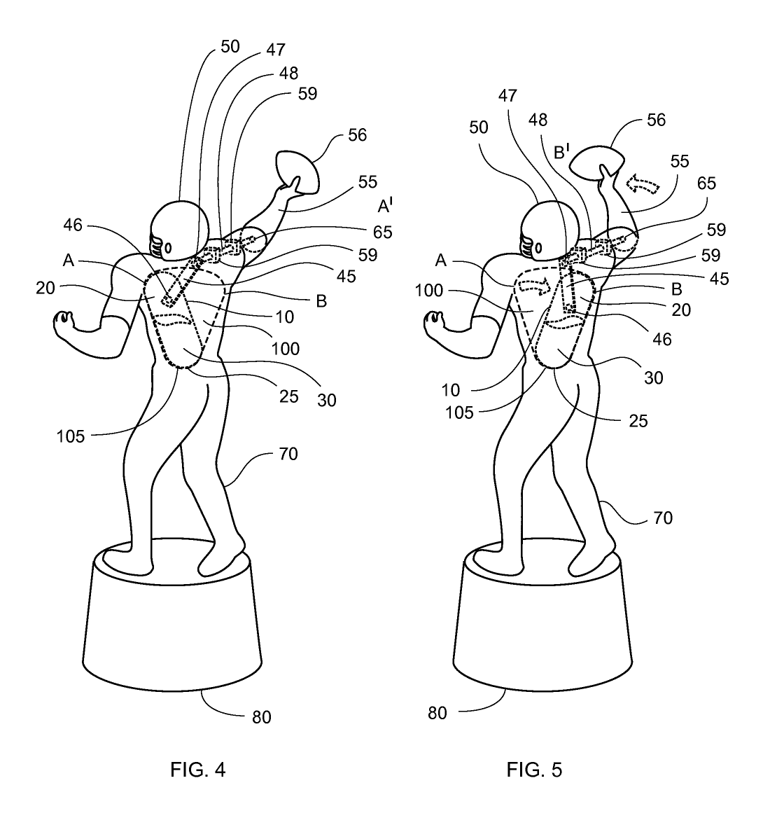

Referring now more specifically to FIGS. 4-6, illustrated therein is an alternate embodiment of fluid engine 10, wherein the alternate embodiment of FIGS. 4-6 is substantially equivalent in form and function to that of the preferred embodiment detailed and illustrated in FIGS. 1-3 except as hereinafter specifically referenced. Specifically, the embodiment of FIGS. 4-6 comprises FIG. 50 having therewithin fluid engine 10, wherein fluid engine 10 comprises container 20 disposed within cavity 100. Fluid engine 10 comprises bottom 25, wherein bottom 25 is disposed within curved bottom 105 of cavity 100, thereby permitting container 20 to pivot back-and-forth within cavity 100 from position A to position B.

Container 20 further comprises movable pivot 46, wherein movable pivot 46 is in communication with plate 45, and wherein plate 45 comprises fixed pivot 47 at the other end from movable pivot 46. Fixed pivot 47 is in communication with rod 48, wherein rod 48 is retained by holders 59, and wherein holders 59 permit rotation of rod 48 therewithin. Rod 48 is secured to arm 55 by joint 65, wherein rotation of rod 48 within holders 59 causes arm 55 to move from position A′ to position B′ as container 20 moves from position A to position B. As arm 55 moves from position A′ to position B′, the appearance of a sports operation is given by arm 55 moving forward appearing to throw football 56.

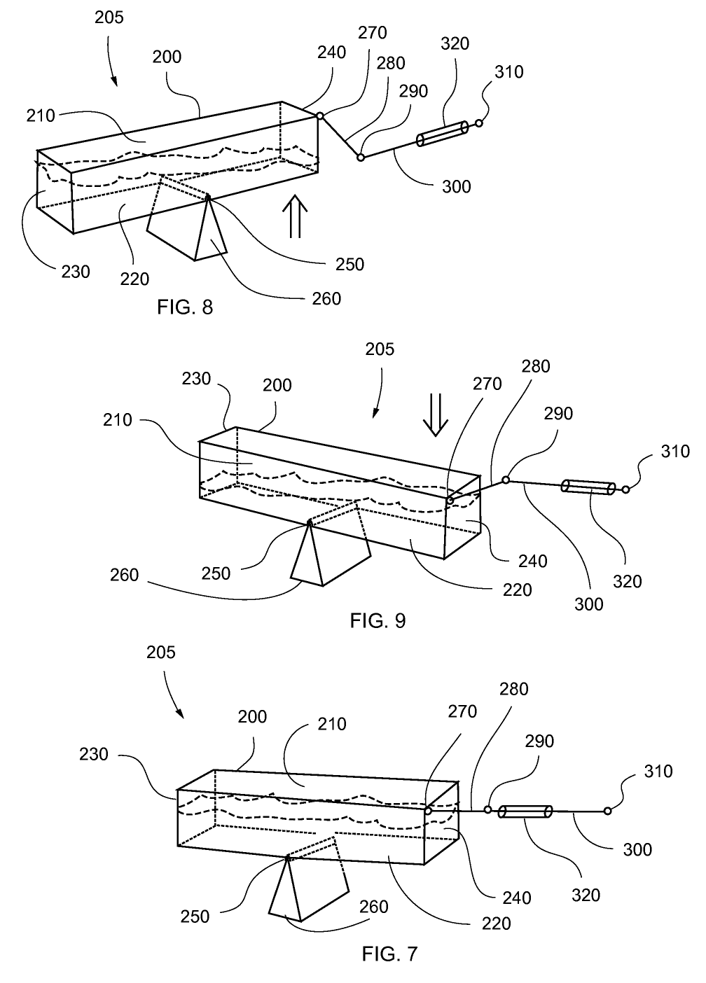

Referring now more specifically to FIGS. 7-9, illustrated therein is an alternate embodiment of fluid engine 10, wherein the alternate embodiment of FIGS. 7-9 is substantially equivalent in form and function to that of the preferred embodiment detailed and illustrated in FIGS. 1-3 except as hereinafter specifically referenced. Specifically, the embodiment of FIGS. 7-9 comprises fluid engine 205, wherein fluid engine 205 comprises container 200, pivot point 250 and base 260, and wherein container 200 comprises first end 230, second end 240 and interior 210. Container 200 is supported on base 260 and is secured thereto via pivot point 250, thereby permitting container 200 to rock back-and-forth about pivot point 250.

Fluid 220 is disposed within interior 210 of container 200, wherein under centrifugal force 110, fluid 220 will move, as applicable from first end 230 toward second end 240 and vice versa. As fluid 220 moves, the weight of increased fluid at end 230, 240 as the case may be, causes container 200 to rock on pivot point 250. Fluid engine 205 further comprises first hinge 270 disposed on second end 240, wherein first hinge 270 is in communication with first member 280, and wherein first member 280 comprises second hinge 290 at the end of first member 280 opposite to first hinge 270. Second hinge 290 is in communication with second member 300, wherein second member 300 is disposed within sleeve 320, and wherein second member 300 comprises joint 310 at the end of second member 300 opposite to second hinge 290. Joint 310 may be secured to appendage 60 (best shown in FIGS. 1-2) or other object for which movement is desired.

As centrifugal force 110 causes container 200 to rock back-and-forth, second end 240 moves up-and-down, pulling and/or pushing first member 280. As second end 240 tilts upward, first member 280 pulls second member 300, wherein second member 300 slides within sleeve 320 causing joint 310 to move to position A. Similarly as second end 240 tilts downward, first member 280 pulls second member 300, wherein second member 300 slides within sleeve 320 causing joint 310 to move to position A. As container 200 reaches a level position, first member 280 pushes second member 300, wherein second member 300 slides within sleeve 320 causing joint 310 to move to position B.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A fluid engine comprising:
a container;
a fluid disposed within said container, wherein said container is less than full; and
an appendage, wherein said appendage is operatively coupled to said container, and wherein said operatively-coupled appendage is urged from one disposition to another by said container when said container is moved by operation of force on said fluid.

2. The fluid engine of claim 1, wherein said container is disposed within an object, and wherein said object comprises a first movable member in communication between said operatively-coupled appendage and said container, and wherein said operatively-coupled appendage is urged from one disposition to another when said first movable member is moved.

3. The fluid engine of claim 2, wherein said first movable member is hingedly-coupled to said operatively-coupled appendage.

4. The fluid engine of claim 2, wherein said container is disposed on a pivot.

5. The fluid engine of claim 2, wherein said container generally comprises a cylinder having a width and a length, and wherein said length is disposed generally vertically.

6. The fluid engine of claim 2, wherein said container comprises a rectangular prism, and wherein said rectangular prism comprises a length, a width and a height, and wherein said length is disposed generally horizontally.

7. The fluid engine of claim 2, wherein said object comprises a figure, and wherein said figure comprises said operatively-coupled appendage.

8. The fluid engine of claim 7, wherein said object is disposed within a vehicle.

9. The fluid engine of claim 8, wherein said object is disposed on dashboard of a car.

10. The fluid engine of claim 2, wherein said first movable member is in pivotal communication with a second movable member.

11. The fluid engine of claim 10, wherein at least a portion of said second movable member is slidably disposed within a retaining member.

12. The fluid engine of claim 2, further comprising a means for securing said fluid engine to a surface.

13. The fluid engine of claim 2, further comprising a second movable member disposed between said first movable member and said operatively-coupled appendage, wherein said second movable member is rotated by said first movable member.

14. The fluid engine of claim 7, wherein said container pivots on a curved bottom of a cavity within said figure.

15. A method of moving an arm member, said method comprising the steps of:
obtaining a fluid engine comprising a container, wherein said arm member is operatively-coupled to said container, and wherein said container comprises a fluid therewithin, and wherein said container is less than full;
disposing said fluid engine in an environment wherein force acts upon said fluid;
connecting a portion of a first movable member to said arm member;
moving said container by operation of force on said fluid; and
urging said first movable member from one disposition to another, thereby moving said arm member.

16. The method of claim 15, further comprising the step of:
disposing said first movable member and said arm member within a figure.

17. The method of claim 16, further comprising the step of:
rotating a second movable member by said urging of said first movable member.

18. The method of claim 16, further comprising the step of:
sliding a second movable member by said urging of said first movable member.

19. The method of claim 15, wherein said step of moving said container comprises:
pivoting said container on a pivot point.

20. An action figure comprising:
a fluid engine, wherein said fluid engine comprises a pivoting container partially filled with fluid;
an appendage; and
a connector in communication between said fluid engine and said appendage of said figure, wherein centrifugal force urges said container to change its disposition, thereby causing said appendage to move.
